(19) United States
(12) Patent Application Publication
(10) Pub. No.: US 2012/0137147 A1
(43) Pub. Date: May 31, 2012

(54) Method of powering down a computer system from a remote power button event

(76) Inventor: Stewart Myers, Philomath, OR (US)

(21) Appl. No.: 12/956,371

(22) Filed: Nov. 30, 2010

(51) Int. Cl. G06F 1/26

(52) U.S. Cl. 713/310

(57) ABSTRACT

A method for powering down a computer system through the use of a remote power button is shown. A remote power button is actuated that generates an interrupt. The interrupt is handled by the power management controller of an operating system or basic input output system. The power management controller causes the computer system to be shut down as according to the basic input output system or operating system power management policies, with or without waiting for critical processes to terminate.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a method for powering down a computer system, more specifically, to a method for powering down a computer system with a remote power button.

2. Description of the Related Art

Almost all personal computers are manufactured with a power button that can be used to turn the computer off. These buttons are usually inset into the computer's frame or chassis and are directly connected to the motherboard. Computers contain power management controllers that monitor the status of the power button. When the user presses the power button, creating a button event, the power management controller generates an interrupt either at the basic input output system (BIOS) level or at the operating system (OS) level. The BIOS or the OS then handles the button event according to their power management policies.

Computers have become increasingly sensitive to sudden losses of power. Immediate power loss can damage computer hardware and lead to corruption of software. Information stored in volatile memory is lost when the computer is powered off and if that data is not written to a tangible medium, such as a hard drive or non-volatile flash memory, it will be permanently unrecoverable. To maintain system integrity, manufacturers and programmers have incorporated safe shutdown procedures into the BIOS and OS power management policies. Activating the system's shutdown procedures usually involves the user clicking through a short menu selection or pressing a certain sequence of keys on the keyboard. Both of these shutdown approaches are time-consuming, somewhat complicated, and require the user to be in very close proximity with the computer so they can physically interact with the hardware.

There are many peripheral devices that have power buttons and are designed to work with computers. These devices only control specific functions like DVR recording, music and video players, and system volume. Pressing their power buttons can close a software application or shut off power to a peripheral device, but do not interface with the OS power management policies or shutdown procedures. Users have no way to remotely shut down their system in a safe and secure manner.

### BRIEF SUMMARY OF THE INVENTION

A simpler, more efficient way to turn off a computer is needed. Users expect near instantaneous response from computer hardware and want the convenience of being able to turn off their computers without being in close physical proximity. The present invention meets those needs by allowing users to quickly and safely turn off their computers from a distance. Through a single click of a button, the present invention allows the user to activate the BIOS or OS shutdown procedures without having to navigate through a shutdown menu or having to press a sequence of keys on the keyboard.

In one embodiment of the present invention, a button is integrated into a computer mouse that generates a system interrupt when pressed. The BIOS or OS power management controller handles the interrupt and initiates computer shutdown as according to its power management policies.

In another embodiment of the present invention, a button is integrated into a wireless remote control device that sends a signal to an integrated or peripheral wireless receiver attached to the computer. Upon receiving the signal, the receiver generates a system interrupt that is handled by the BIOS or OS power management controller and the computer is shutdown as according to its power management properties.

### BRIEF DESCRIPTION OF THE SEVERAL VIEWS OF THE DRAWING(S)

FIG. 1 is a block diagram of a computer system with a remote power button as according to one embodiment of the invention.

FIG. 2 is a flow chart diagram of a method for powering down a computer system utilizing a wired remote power button as according to one embodiment of the invention.

FIG. 3 is a flow chart diagram of a method for powering down a computer system utilizing a wireless remote power button as according to one embodiment of the invention.

FIG. 4A is the top view of a remote power button integrated into a computer mouse with which one embodiment of the invention may be implemented.

FIG. 4B is the side view of a remote power button integrated into a computer mouse with which one embodiment of the invention may be implemented.

FIG. 5 is the top view of a remote power button integrated into a wireless remote control with which one embodiment of the invention may be implemented.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention,” “alternative embodiment(s),” and “exemplary embodiment(s)” do not require that all embodiments of the method, system and apparatus include the discussed feature, advantage or mode of operation.

The following descriptions of the preferred embodiments are merely exemplary in nature and are in no way intended to limit the invention, its application, or uses. It should be pointed out that the positions chosen for the purposes of the description, such as top, bottom, side, etc., relate to the drawing specifically being described and can be transposed in terms of meaning to a new position when another position is being described.

A computer BIOS is built-in software that is run initially on startup of the computer. The BIOS contains all the code required to control the peripheral devices of the computer, such as keyboard, display screen, disk drives, serial communications, and the like.

The BIOS is typically stored on a read only memory (ROM) chip. Since it is stored on a dedicated chip, the BIOS is protected from many disk and memory failures. The BIOS may contain power management policies that can be copied to computer random access memory (RAM) and operate in conjunction with, or independently of, OS power management policies.

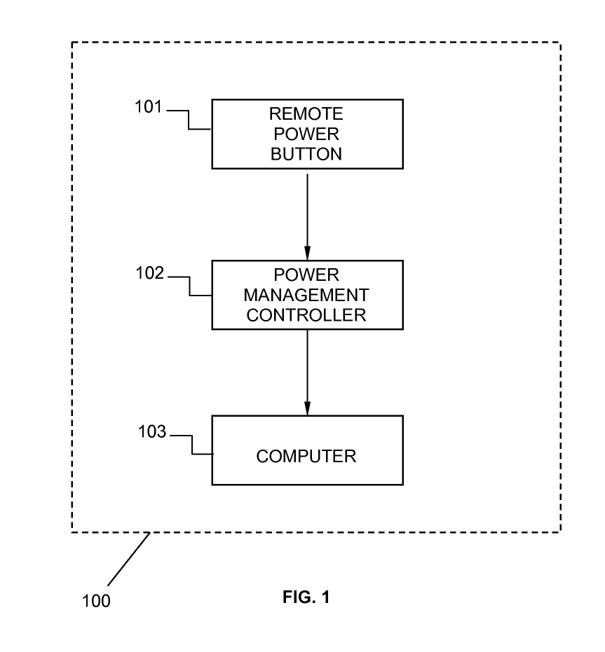

Referring to FIG. 1 there is shown a computer system 100 having a remote power button for powering down the system 100 as according to an exemplary embodiment of the invention. The system includes a remote power button 101, a power management controller 102, and a computer 103. The remote power button 101 is, in one exemplary embodiment, built into a peripheral device that communicates with the computer 101 through a wired connection. The remote power button 101 is, in another exemplary embodiment, built in to a peripheral device that communicates with the computer 101 wirelessly. The shutdown functionality of the remote power button 101 can be implemented in any number of ways such as by electrical components or software. The remote power button 101 is coupled to the power management controller 102. For this exemplary embodiment, the power management controller is an OS handler or a BIOS handler. The computer 103 is coupled to the power management controller 102. The computer 102 has a processor, memory, power supply, and other components commonly found in a computer.

The remote power button 101 generates a button event when pressed. If the computer 103 is on when the remote power button 101 is pressed, the button event is a computer shutdown event. The power management controller 102 receives the computer shutdown event generated by the remote power button 101. The power management controller 102 handles the computer shutdown event according to its power management policies. The policies may be factory default settings, user defined settings, dynamically determined by the power management controller 102, or other settings intended to shut down the computer. The power management policies may cause a computer 103 shutdown with or without allowing certain process to save or terminate before shutdown. Alternatively, the power management policies may not allow a shutdown and the computer 103 will remain powered on.

In an exemplary embodiment of the invention, the power management controller 102 physically resides within the computer 103 while the remote power button 101 physically resides within a peripheral device that communicates through a wired or wireless connection to the computer 103.

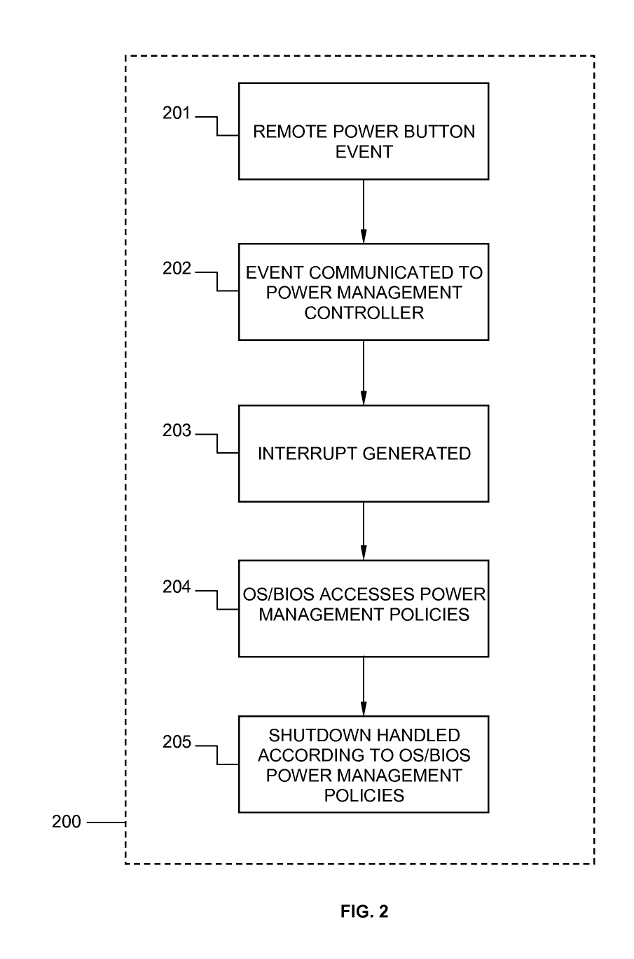

Referring to FIG. 2 there is shown a flowchart of an exemplary embodiment of the method for shutting down a computer system with a remote power button event that utilizes a wired connection 200.

The actuation of a remote power button generates a remote power button event 201. The remote power button event 201 is communicated to the power management controller 202 through a wired connection and the power management controller 202 generates a computer shutdown interrupt 203. The shutdown interrupt 203 is received by the OS or the BIOS and the OS or BIOS responds to the shutdown interrupt 203 by accessing the computer system's power management policies 204. The power management policies handle the computer system shutdown 205. The power management policies' handling of the computer shutdown 205 may include shutting the system off with or without allowing certain processes to save or terminate prior to shutdown, or the policies may disallow a shutdown and the computer system will remain powered on.

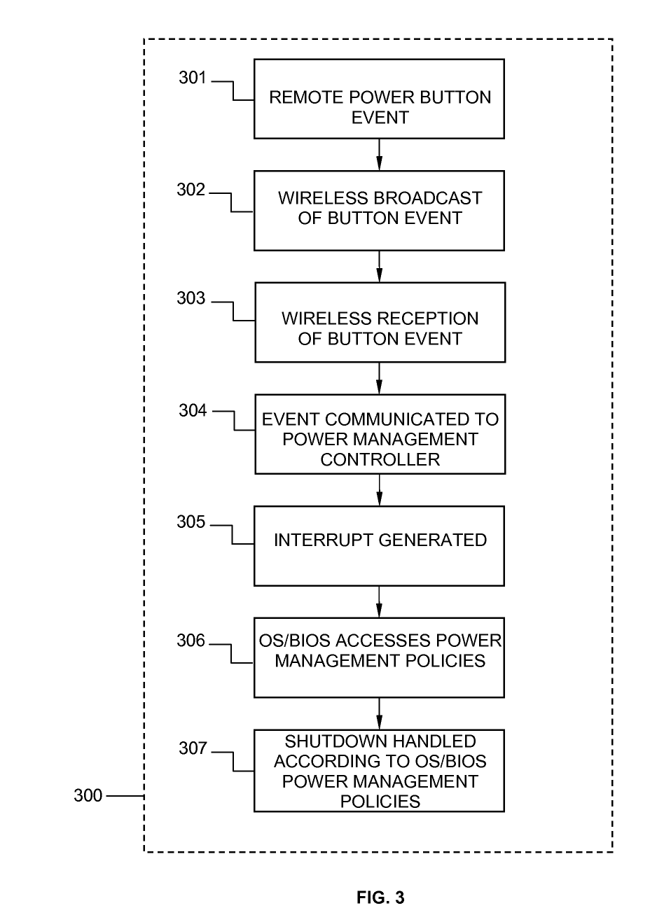

Referring to FIG. 3 there is shown a flowchart of an exemplary embodiment of the method 300 for shutting down a computer system with a remote power button event that utilizes a wireless connection.

The actuation of a remote power button generates a remote power button event 301. The remote power button event 301 is broadcast by a peripheral computer device 302. The broadcast of the remote power button event is received by a peripheral wireless receiver 303. The wireless receiver communicates the remote power button event 301 to the power management controller 304 and the power management controller 304 generates a computer shutdown interrupt 305. The shutdown interrupt 305 is received by the OS or the BIOS and the OS or BIOS responds to the shutdown interrupt 305 by accessing the computer system's power management policies 306. The power management policies handle the computer system shutdown 307. The power management policies' handling of the computer shutdown 307 may include shutting the system off with or without allowing certain processes to save or terminate prior to shutdown, or the policies may disallow a shutdown and the computer system will remain powered on.

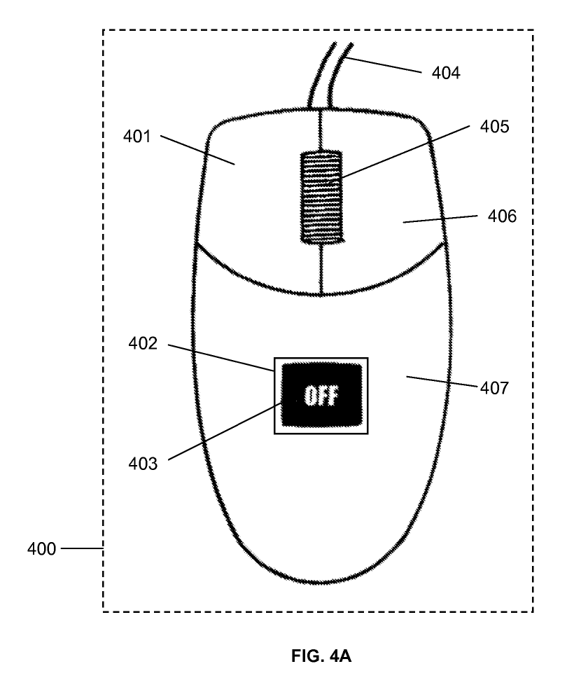

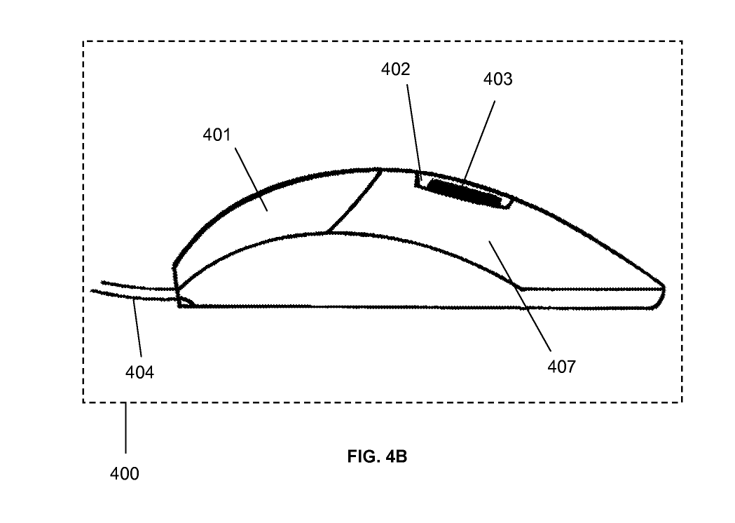

Referring to FIG. 4A and FIG. 4B, which will be described together, there is shown an exemplary embodiment of the method for shutting down a computer system with a remote power button event utilizing a wired peripheral device, in this case a computer mouse 400. A computer mouse 400 typically has a left mouse button 401, a right mouse button 406, and a center scroll wheel 405. An exemplary remote power button 403 is integrated into the computer mouse body 407 and is inset in a power button recess 402 to prevent accidental actuation. A computer user usually operates the computer mouse 400 with either their left or right hand resting on the computer mouse body 407 and their fingers extending over the left mouse button 401, right mouse button 406, and center scroll wheel 405. The computer user can shut down the computer system by pressing the remote power button 403. The signal from the remote power button 403 is communicated to the computer power management controller through the attached mouse cord 404. The mouse cord 404 can connect to a computer via connection types that include, but are not limited to, a universal serial bus connection, an IBM Personal System/2 connection, or a serial mouse connection.

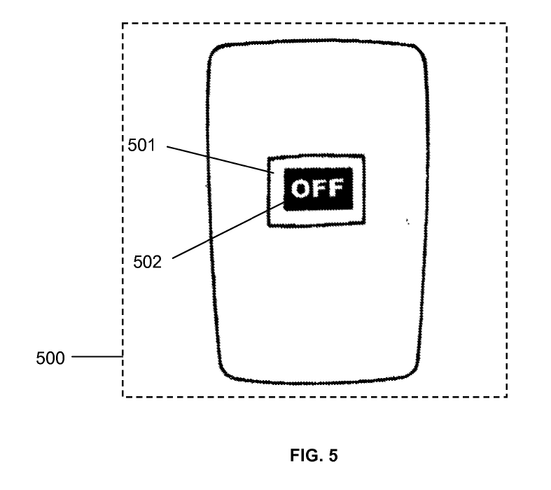

Referring to FIG. 5 there is shown an exemplary embodiment of the method for shutting down a computer system with a remote power button event utilizing a wireless peripheral device, in this case a remote control 500. The remote control 500 has a power button recess 501 into which a remote power button 502 has been constructed. A computer user can shut down a computer system by pressing the remote power button 502. The signal from the remote power button 502 is received by a receiver attached to the computer system. The receiver communicates the remote power button actuation to the computer system power management controller.

Method 200, system 100 and any variations thereof may be implemented partially or wholly in wired peripheral devices such as the computer mouse shown in FIG. 4A and FIG. 4B. Method 300, system 100 and any variations thereof may be implemented partially or wholly in wireless peripheral devices such as the remote control shown in FIG. 5. Methods 200, 300, system 100 and any variations thereof may be implemented partially or wholly in computer programs. The computer programs may comprise multiple modules or objects to perform methods 200, 300, or the functions of modules in system 100.

The type of computer programming languages used to write code for implementing any embodiment of the present invention may vary between procedural code type languages to object oriented languages. The files or objects need not have a one to one correspondence to the modules or method steps described depending on the desires of the programmer. Further, the method and apparatus of any embodiment of the present invention may comprise combinations of software, hardware and firmware as is well known to those skilled in the art.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the following claims, and the full scope of equivalents thereof.

I claim:

1. A method for powering down a computer system comprising: actuating a remote power button; generating an interrupt in response to the actuation of the remote power button; powering down the computer system by the system software in response to the system software responding to the interrupt.

2. The method of claim 1, wherein handling the interrupt by the system software comprises handling the interrupt according to a power management policy.

3. The method of claim 1, wherein the system software is an operating system.

4. The method of claim 1, wherein the system software is a basic input output system.

5. The method of claim 1, wherein the remote power button resides in a peripheral device that communicates with the computer system through a wired connection.

6. The method of claim 1, wherein the remote power button resides in a peripheral device that communicates with the computer system through a wireless connection.

7. The method of claim 1, wherein powering down the computer system by the system software comprises waiting until critical processes have terminated processing before powering down the computer system.

8. A method for powering down a computer system comprising: generating a remote power button event; generating an interrupt in response to the remote power button event; handling the remote power button event through a basic input output system (BIOS) if the system is set to handle power button events through the BIOS; handling the remote power button event through an operating system (OS) if the system is set to handle power button events through the OS.

9. The method of claim 8, wherein said interrupt is a BIOS interrupt and wherein handling power button events by the BIOS comprises: generating the BIOS interrupt in response to the remote power button event; and handling the power button event according to BIOS power management policies.

10. The method of claim 8, wherein said interrupt is a OS interrupt and wherein handling power button events by the OS comprises: generating the OS interrupt in response to the remote power button event; and handling the power button event according to OS power management policies.

11. The method of claim 8, wherein the remote power button resides in a peripheral device that communicates with the computer system through a wired connection.

12. The method of claim 8, wherein the remote power button resides in a peripheral device that communicates with the computer system through a wireless connection.

13. The method of claim 9, wherein handling the power button event according to BIOS power management policies comprises waiting until critical processes have terminated processing before powering down the computer system.

14. The method of claim 10, wherein handling the power button event according to OS power management policies comprises waiting until critical processes have terminated processing before powering down the computer system.

15. A method for powering down a computer system, comprising: generating an interrupt on a remote power button input; handling the remote power button input by the operating system (OS); and handling the power button input by the basic input output system (BIOS) if the OS fails to respond to the interrupt.

16. The method of claim 15, wherein handling the remote power button input by the OS comprises handling the remote power button input according to OS power management policies.

17. The method of claim 15, wherein handling the remote power button input by the BIOS comprises handling the remote power button input according to BIOS power management policies.

18. The method of claim 16, wherein handling the remote power button input according to OS power management policies comprises waiting until critical processes have terminated processing before powering down the computer system.

19. The method of claim 17, wherein handling the remote power button input according to BIOS power management policies comprises waiting until critical processes have terminated processing before powering down the computer system.

20. The method of claim 15, wherein the remote power button resides in a peripheral device that communicates with the computer system through a wired connection.

21. The method of claim 15, wherein the remote power button resides in a peripheral device that communicates with the computer system through a wireless connection.
